(19) United States
(12) Patent Application Publication
(10) Pub. No.: US 2010/0054829 A1
(43) Pub. Date: Mar. 4, 2010

(54) Protective layer forming device, image forming apparatus and process cartridge

(75) Inventors: Masato Iio, Yokohama-shi (JP); Hiroshi Nakai, Yokohama-shi (JP); Masahide Yamashita, Tokyo (JP); Shinya Tanaka, Sagamihara-shi (JP); Naoyuki Ozaki, Zama-shi (JP); Kunio Hasegawa, Isehara-shi (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/461,800

(22) Filed: Aug. 25, 2009

(30) Foreign Application Priority Data
Sep. 3, 2008 (JP) 2008-226341

(51) Int. Cl. G03G 21/00

(52) U.S. Cl. 399/346; 399/350

(57) ABSTRACT

A protective layer forming device including an image-bearing member protecting agent which contains a fatty acid metal salt and an inorganic lubricant, a protecting agent supply member configured to apply a surface of the image bearing member with the image-bearing member protecting agent, and a leveling member configured to level off the image-bearing member protecting agent applied on the surface of the image bearing member, wherein the leveling member serves as a cleaning blade having a ridge part with an obtuse angle, which comes into contact with the surface of the image bearing member in a direction counter to the rotation of the image bearing member.

### BACKGROUND OF THE INVENTION

1. Field of the Invention

The present invention relates to a protective layer forming device for forming a protective layer using a protecting agent on a surface of an image bearing member, and an electrophotographic image forming apparatus and a process cartridge, which include the protective layer forming device.

2. Description of the Related Art

Conventionally, in electrophotographic image formation, a latent electrostatic image is formed on an image bearing member made from a photoconductive material, and charged toner particles are attached to the latent electrostatic image so as to form a visible image. The visible image formed with the toner particles is transferred onto a recording medium such as paper, or the like, and then fixed on the recording medium utilizing heat, pressure, solvent gas or the like so as to form an output image.

Methods for the image formation are broadly classified, according to methods for charging toner particles to form a visible image, into so-called two-component developing methods in which frictional charging effected by stirring and mixing toner particles and carrier particles is utilized, and so-called one-component developing methods in which toner particles are charged without using carrier particles. Further, the one-component developing methods are classified into magnetic one-component developing methods and nonmagnetic one-component developing methods, according to whether or not magnetic force is utilized to keep toner particles on a developing roller.

In image forming apparatuses, such as copiers, complex machines based upon the copiers, and the like for which high-speed processing capability and image reproducibility are required, the two-component developing methods have been employed in many cases due to demands for stable chargeability of toner particles, stable charge rising properties of the toner particles, long-term stability of image quality, and the like; whereas in compact printers, facsimiles, etc. for which space saving, cost reduction and the like are required, the one-component developing methods have been employed in many cases.

Also, nowadays in particular, colorization of output images is progressing, and demands for improvement of image quality and stabilization of image quality are increasing like never before.

For the improvement of image quality, toners have been made smaller in average particle diameter, and particles of the toners have been made rounder in shape with their angular parts removed.

Generally, in an image forming apparatus which operates in accordance with any such electrophotographic image forming method, regardless of which developing method is employed, a drum-shaped or belt-shaped image bearing member (typified by a photoconductor) is uniformly charged while being rotated, a latent image pattern is formed on the image bearing member by laser light or the like, and the latent image pattern is visualized as a toner image by a developing unit and transferred onto a recording medium.

After the toner image has been transferred onto the recording medium, untransferred toner components remain on the image bearing member. If such residues are directly conveyed to a region for the charging step, it often hinders the image bearing member from being uniformly charged; accordingly, in general, the toner components, etc. remaining on the image bearing member are removed by a cleaning step by a cleaning unit after the transfer step, thereby bringing the surface of the image bearing member into a clean enough state, and then charging is carried out.

Thus, there are various types of physical stress and electrical stress in each step in image formation, which deteriorate the image bearing member, charging member and cleaning member. In attempts to solve this problem, a number of proposals for lubricants and methods of supplying lubricating components and forming films of lubricating components have been made thus far to reduce deterioration of the image bearing member, charging member and cleaning member (see Japanese Patent Application Publication (JP-B) No. 51-22380, Japanese Patent Application Laid-Open (JP-A) Nos. 2006-350240, 2007-145993, 2006-154747 and 2006-251751).

For example, Japanese Patent Application Publication (JP-B) No. 51-22380 proposes a method of forming a lubricant film on a photoconductor surface by supplying the photoconductor surface with a solid lubricant composed mainly of zinc stearate in order to lengthen the lifetimes of a photoconductor and a cleaning blade. This makes it possible to reduce abrasion of the photoconductor surface and thus lengthen the lifetime of the photoconductor.

However, it is understood that fatty acid metal salts such as zinc stearate lose their lubricating properties at an early stage due to electric discharge performed in the vicinity of the image bearing member in a charging step. Consequently, the lubricating properties between the cleaning blade and the image bearing member is impaired, and toner particles pass through therebetween (hereinafter also referred to as toner leakage), and thus defective images are formed.

In an attempt to solve these problems, JP-A No. 2006-350240 proposes a method of applying an image-bearing member protecting agent which contains a fatty acid metal salt and boron nitride. By the use of the typical cleaning blade having a reed-shaped tip, the lubricating properties between a cleaning blade and an image bearing member can be maintained by means of a lubricating effect of the boron nitride even under the influence of electric discharge performed in the vicinity of the image bearing member in a charging step, and toner leakage can be decreased in some degree.

However, in the configuration disclosed in JP-A No. 2006-350240, the lubricating effect of the boron nitride enables to decrease the toner leakage, but cannot prevent the toner leakage completely. As a result, the toner leakage may cause defective images.

In JP-A No. 2007-145993, at least two types of higher fatty acid metal salts having different numbers of carbon atoms are used in order to improve the formability of an image-bearing member protecting agent with a large aspect ratio. In this configuration, the formability of an image-bearing member protecting agent is improved.

However, in the configuration disclosed in JP-A No. 2007-145993, the lubricating properties are reduced by the use of the different types of fatty acid metal salts, causing acceleration of the toner leakage and smearing on the charging member.

JP-A No. 2006-154747 discloses a configuration, in which a cleaning blade has a tip with an obtuse angle, and a contact width with respect to the image bearing member, and a contact pressure, a linear pressure, a free length, a hardness and an impact resilience of the cleaning blade are defined so as to enhance toner removal efficiency.

However, in the configuration disclosed in JP-A No. 2006-154747, when the surface of the image bearing member is deteriorated by charging, and the vibration of the tip of the cleaning blade becomes larger, causing toner leakage, and thus defective images are formed. If a fatty acid metal salt is used to protect the surface of the image bearing member, the lubricating properties may be impaired as in JP-B No. 51-22380. Consequently, the tip of the cleaning blade excessively vibrates, causing toner leakage.

JP-A No. 2006-251751 discloses a configuration of providing a cleaning member for removing contaminant on the image bearing member before a step of applying a fatty acid metal salt as a lubricant, and a leveling member for spreading the lubricant on the image bearing member so as to form a thin layer after the step of applying the fatty acid metal salt as the lubricant, thereby obtaining uniform coating. However, in the configuration disclosed in JP-A No. 2006-251751, the fatty acid metal salt deteriorated in the charging step causes poor cleanability of the cleaning member as in JP-B No. 51-22380, and the deteriorated fatty acid metal salt reaches the leveling member together with a toner. Therefore, cleanability of the leveling member is also decreased, causing toner leakage.

### BRIEF SUMMARY OF THE INVENTION

An object of the present invention is to provide a protective layer forming device for forming an image bearing member protective layer which can prevent abrasion of an image bearing member, filming, smearing on charging member and toner leakage, and an image forming apparatus and a process cartridge, which can obtain high quality images in a stable manner for a long period of time.

Means for solving the above problems are as follows:
<1> A protective layer forming device including an image-bearing member protecting agent which contains a fatty acid metal salt and an inorganic lubricant; a protecting agent supply member configured to apply a surface of the image bearing member with the image-bearing member protecting agent; and a leveling member configured to level off the image-bearing member protecting agent applied on the surface of the image bearing member, wherein the leveling member serves as a cleaning blade having a ridge part with an obtuse angle, which comes into contact with the surface of the image bearing member in a direction counter to the rotation of the image bearing member.
<2> The protective layer forming device according to <1>, wherein the cleaning blade has an obtuse angle of 95 degrees to 170 degrees.
<3> The protective layer forming device according to <1>, wherein the cleaning blade has a contact linear pressure of 0.1 N/cm to 2 N/cm.
<4> The protective layer forming device according to <1>, wherein the cleaning blade has a Young's modulus at 23° C. of 0.03 N/cm² to 0.2 N/cm².
<5> The protective layer forming device according to <1>, wherein the cleaning blade is in contact with the image bearing member with a width of 10 μm to 100 μm.
<6> The protective layer forming device according to <1>, wherein the image-bearing member protecting agent is supplied via the protecting agent supply member to the surface of the image bearing member.
<7> An image forming apparatus including an image bearing member, a latent electrostatic image forming unit configured to form a latent electrostatic image on the image bearing member, a developing unit configured to develop the latent electrostatic image using a toner so as to form a visible image, a transfer unit configured to transfer the visible image onto a recording medium, and a protective layer forming unit configured to form a protective layer on a surface of the image bearing member, wherein the protective layer forming unit includes an image-bearing member protecting agent which contains a fatty acid metal salt and an inorganic lubricant; a protecting agent supply member configured to apply a surface of the image bearing member with the image-bearing member protecting agent; and a leveling member configured to level off the image-bearing member protecting agent applied on the surface of the image bearing member, wherein the leveling member serves as a cleaning blade having a ridge part with an obtuse angle, which comes into contact with the surface of the image bearing member in a direction counter to the rotation of the image bearing member.
<8> The image forming apparatus according to <7>, further including a cleaning unit configured to remove a toner remaining on the surface of the image bearing member in a downstream of the transfer unit and an upstream of the protective layer forming unit.
<9> The image forming apparatus according to <7>, wherein the latent electrostatic image forming unit includes a charging unit located in contact with or close to the surface of the image bearing member.
<10> The image forming apparatus according to <9>, wherein the charging unit includes a voltage applying unit configured to apply a voltage which includes an AC component.
<11> A process cartridge including an image bearing member, and a protective layer forming unit configured to form a protective layer on a surface of the image bearing member, wherein the process cartridge is detachably attached to a main body of the image forming apparatus, and wherein the protective layer forming unit includes an image-bearing member protecting agent which contains a fatty acid metal salt and an inorganic lubricant; a protecting agent supply member configured to apply a surface of the image bearing member with the image-bearing member protecting agent; and a leveling member configured to level off the image-bearing member protecting agent applied on the surface of the image bearing member, wherein the leveling member serves as a cleaning blade having a ridge part with an obtuse angle, which comes into contact with the surface of the image bearing member in a direction counter to the rotation of the image bearing member.
<12> The process cartridge according to <11>, further including a cleaning unit configured to remove a toner remaining on the surface of the image bearing member in an downstream of the transfer unit and an upstream of the protective layer forming unit.
<13> The process cartridge according to <11>, wherein the latent electrostatic image forming unit includes a charging unit located in contact with or close to the surface of the image bearing member.

The present invention provides a protective layer forming device which can protect an image bearing member from electrical stress caused by charging, and mechanical stress caused by rubbing the image bearing member with the cleaning member, while reducing the influence of a protecting agent deteriorated due to the electrical stress, on image quality and surrounding members of the image bearing member, and an image forming apparatus and a process cartridge using the protective layer forming device.

### BRIEF DESCRIPTION OF THE DRAWINGS

FIG. 1A is a schematic view showing an example of a protective layer forming device of the present invention.

FIG. 1B is a schematic view showing an example of a leveling member 24.

FIG. 2 is a schematic view showing another example of a protective layer forming device of the present invention.

FIG. 3 is a schematic view showing an example of a process cartridge of the present invention.

FIG. 4 is a schematic view showing an example of an image forming apparatus of the present invention.

### DETAILED DESCRIPTION OF THE INVENTION

### (Protective Layer Forming Device)

A protective layer forming device of the present invention includes an image-bearing member protecting agent which contains a fatty acid metal salt and an inorganic lubricant, a protecting agent supply member and a leveling member, and further includes other members as necessary.

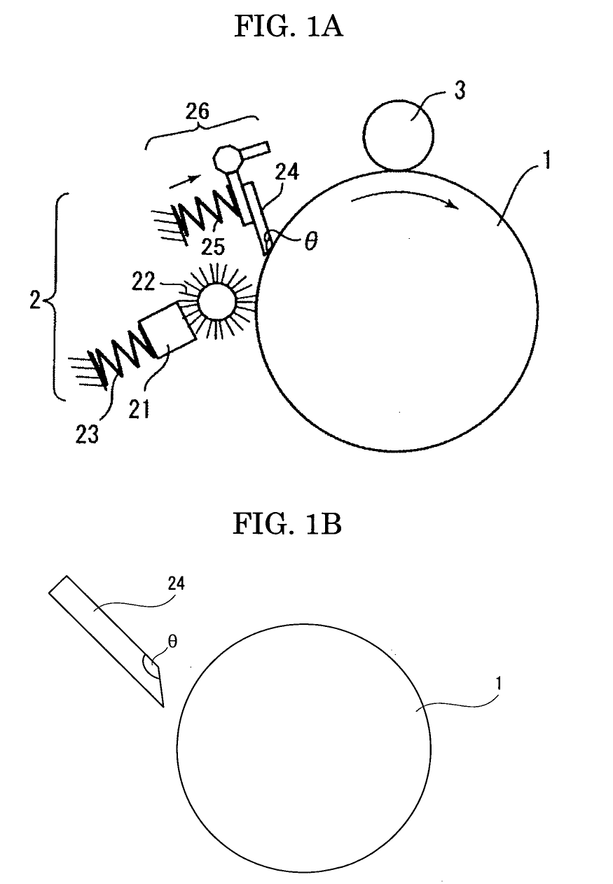

FIG. 1A shows a schematic view showing an example of a protective layer forming device of the present invention.

A protective layer forming device 2 is placed facing a photoconductor drum 1 as an image bearing member, and mainly includes a powdery image-bearing member protecting agent 21, a protecting agent supply member 22, a protecting agent stirring member 23, and a leveling section 26.

The image-bearing member protecting agent 21 of the present invention is stirred with the protecting agent stirring member 23, and drawn up, for example, by the brush-shaped protecting agent supply member 22. The protecting agent supply member 22 rotates at a linear velocity different from that of the image bearing member 1 and rubs the surface of the image bearing member 1, so as to supply the surface of the image bearing member with the image-bearing member protecting agent held on the surface of the protecting agent supply member.

The image-bearing member protecting agent supplied onto the surface of the image bearing member is formed into a thin layer by the protective layer forming device 2 having a blade-shaped member so as to uniformly form an image bearing member protective layer.

The image-bearing member protecting agent used in the present invention includes at least a fatty acid metal salt (A) and an inorganic lubricant (B), and further includes other components as necessary.

Examples of the fatty acid metal salt (A) include, but are not limited to, barium stearate, lead stearate, iron stearate, nickel stearate, cobalt stearate, copper stearate, strontium stearate, calcium stearate, cadmium stearate, magnesium stearate, zinc stearate, zinc oleate, magnesium oleate, iron oleate, cobalt oleate, copper oleate, lead oleate, manganese oleate, zinc palmitate, cobalt palmitate, lead palmitate, magnesium palmitate, aluminum palmitate, calcium palmitate, lead caprylate, lead caprate, zinc linolenate, cobalt linolenate, calcium linolenate, zinc ricinoleate and cadmium ricinoleate. These may be used alone or in combination. Zinc stearate is particularly preferred because it has excellent film formation on the image bearing member.

The inorganic lubricant (B) herein mentioned means a substance which exhibits lubricating properties by being cleaved or which induces internal lubricating action. Examples thereof include, but are not limited to, mica, boron nitride, molybdenum disulfide, tungsten disulfide, talc, kaolin, montmorillonite, calcium fluoride and graphite. These may be used alone or in combination. Of these, boron nitride is preferable because it is a substance in which hexagonal lattice planes formed by firmly bonded atoms are stacked on top of one another with sufficient space between each and thus a weak van der Waals force is the only force which links layers together; therefore, the layers are easily separated from one another and exhibits excellent lubricating properties.

The inorganic lubricant (B) is preferably contained in the image-bearing member protecting agent in an amount of 5% by mass to 30% by mass.

In the present invention, a powdery protecting agent formed of a mixture of these materials is preferably used.

In the present invention, the powdery protecting agent may be molded into a bar shape by compression molding the powdery protecting agent or melt molding a mixed powder, as necessary. In this case, the image bearing member is supplied with the protecting agent generally in such a manner that the bar is press contacted to the protecting agent supply member 22 using a press spring 25 so as to scrape the bar with the protecting agent supply member 22.

The image bearing member on which the protective layer is formed is charged in such a manner that the charging roller 3, on which direct current or direct current superimposed with alternate current applied from a high-voltage generator (not shown), is in contact with or close to the surface of the image bearing member so as to discharge electricity in a minute gap between the charging roller 3 and the image bearing member. During this process, electrical stress causes decomposition and oxidization in some areas of the protective layer, and discharge products in the air may adhere onto the surface of the protective layer.

The deteriorated image-bearing member protecting agent is removed together with other components such as toner particles remaining on the surface of the image bearing member by the leveling section 26.

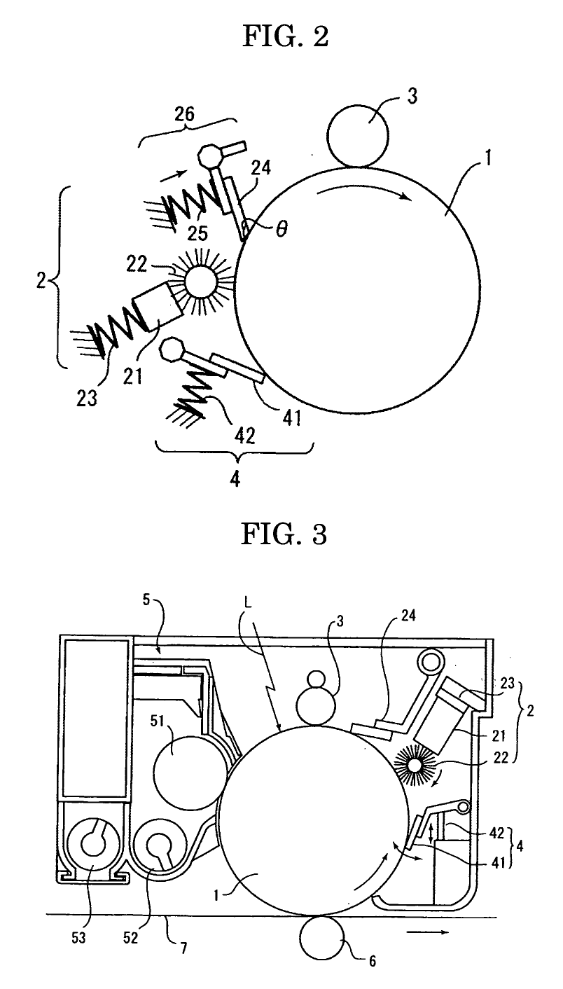

The leveling section 26 may also be served as a cleaning mechanism. However, adequate friction requirement for removing residue remaining on the surface of the image bearing member may not be the same as that for forming the protective layer, thus these functions are preferably separated. As shown in FIG. 2, a cleaning mechanism 4 which includes a cleaning member 41 and a cleaning pressing force mechanism 42 are preferably located in the upstream side of the image-bearing member protecting agent supply member with respect to the rotation direction of the image bearing member.

The material used for a cleaning blade of a leveling member 24 in the leveling section 26 is not particularly limited, and may be appropriately selected depending on the purpose. Examples thereof include a urethane rubber, hydrin rubber, silicone rubber and fluorine rubber. These elastic materials may be used alone or in a blended manner. Additionally, a portion of the rubber blade, which comes into contact with the image bearing member, may be coated or impregnated with a low friction coefficient material. Further, in order to adjust the hardness of the elastic material used, fillers such as organic fillers or inorganic fillers may be dispersed in the elastic material.

The blade is fixed on a blade support by any method such as adhesion or fusion bond so that a tip of the blade can be press contacted with the surface of the image bearing member.

The thickness of the blade cannot be unequivocally defined because the thickness is decided in view of the force applied when the blade is pressed. The thickness is preferably 0.5 mm to 5 mm, and more preferably 1 mm to 3 mm.

Similarly, the length of the blade which protrudes from the blade support and may bend, so-called free length, cannot be unequivocally defined because the length is decided in view of the force applied. The length is preferably 1 mm to 15 mm, and more preferably 2 mm to 10 mm.

The tip shape of the blade which comes into contact with the image bearing member is usually reed-shaped. The inorganic lubricant (B) assists the lubricating properties of the deteriorated image-bearing member protecting agent. However, the lubricating properties are decreased in some degree and the tip of the blade buckles at the contact portion, and the toner and the image-bearing member protecting agent are hard to be cleaned.

In the present invention, as shown in FIG. 1B, the tip of the leveling member 24, which comes into contact with the image bearing member 1 is defined as a ridge part, and has an obtuse angle θ, and the deteriorated image-bearing member protecting agent and the inorganic lubricant (B) exhibit the lubricating effect, so as to suppress the buckling of the tip of the leveling member 24 and maintain high cleanability. When the ridge part of the blade has an obtuse angle θ of 95 degrees to 170 degrees, the blade is preferably used. When the ridge part of the blade has an obtuse angle θ of 100 degrees to 150 degrees, there is less possibility to attach a cut surface onto the image bearing member in a large area, and thus the blade is more preferably used.

To reduce the vibration of the tip of the blade and improve abrasion resistance, the elastic material preferably has a Young's modulus at 23° C. of 0.03 N/cm² to 0.2 N/cm², and more preferably 0.6 N/cm² to 0.15 N/cm². The lower limit of the Young's modulus is determined within a range where the blade exhibits effect of removal of the toner or the image-bearing member protecting agent.

The cleaning blade is preferably in contact with the image bearing member with a width of 10 μm to 100 μm. In the range of the above-mentioned Young's modulus, the pressing force needs to be excessively increased in order to have a contact width of more than 100 μm, and the abrasion resistance of the blade or the image bearing member is decreased. When the contact width is up to 70 μm, the margin of the abrasion of the blade or the image bearing member is increased, thus the blade is more preferably used. In view of the accuracy of the image bearing member and toner particle diameter, the lower limit of the contact width is preferably 10 μm.

The leveling member 24 is pressed counter to the rotation direction of the image bearing member using the elastic member 25 with an appropriate pressing force to spread the image-bearing member protecting agent so as to be formed into a protective layer or protective film, as a contact linear pressure of 0.1 N/cm to 2 N/cm.

A brush-shaped member is preferably used as the protecting agent supply member 22; in this case, brush fibers of the brush-shaped member preferably have flexibility to reduce mechanical stress on the surface of the image bearing member.

As the material for the flexible brush fibers, resins having flexibility among the following materials may be used. Examples thereof include polyolefin resins such as polyethylene and polypropylene; polyvinyl resins and polyvinylidene resins such as polystyrene, acrylic resins, polyacrylonitrile, polyvinyl acetate, polyvinyl alcohol, polyvinyl butyral, polyvinyl chloride, polyvinyl carbazole, polyvinyl ethers and polyvinyl ketones; vinyl chloride-vinyl acetate copolymers; styrene-acrylic acid copolymers; styrene-butadiene resins; fluorine resins such as polytetrafluoroethylene, polyvinyl fluoride, polyvinylidene fluoride and polychlorotrifluoroethylene; polyesters; nylons; acrylics; rayons; polyurethanes; polycarbonates; phenol resins; and amino resins such as urea-formaldehyde resins, melamine resins, benzoguanamine resins, urea resins and polyamide resins.

To adjust the extent to which the brush bends, diene rubber, styrene-butadiene rubber (SBR), ethylene propylene rubber, isoprene rubber, nitrile rubber, urethane rubber, silicone rubber, hydrin rubber, norbornene rubber and the like may be used in combination.

A support for the protecting agent supply member 22 may be a stationary support or a roll-shaped rotatable support. The protecting agent supply member having the roll-shaped support is exemplified by a roll brush formed by spirally winding a tape made of a pile fabric formed of brush fibers around a metal core. Each brush fiber preferably has a diameter of approximately 10 μm to 500 μm and a length of 1 mm to 15 mm, and the number of the brush fibers is preferably 10,000 to 300,000 per square inch (1.5×10⁷ to 4.5×10⁸ per square meter).

For the protecting agent supply member 22, use of a material having a high brush fiber density is highly desirable in terms of uniformity and stability of the supply. It is preferred that one fiber be formed from several to several hundreds of fine fibers. Specifically, 50 fine fibers of 6.7 decitex (6 denier) may be bundled together and planted as one fiber, as exemplified by the case of 333 decitex=6.7 decitex×50 filaments (300 denier=6 denier×50 filaments).

Additionally, if necessary, the brush surface may be provided with a coating layer for the purpose of stabilizing the shape of the brush surface, the environment stability, and the like.

As a component of the coating layer, the component capable of deforming in conformity to the bending of the brush fibers is preferably used, and the component is not limited in any way as long as it can maintain its flexibility. Examples of the component include polyolefin resins such as polyethylene, polypropylene, chlorinated polyethylene and chlorosulfonated polyethylene; polyvinyl resins and polyvinylidene resins, such as polystyrene, acrylics (e.g. polymethyl methacrylate), polyacrylonitrile, polyvinyl acetate, polyvinyl alcohol, polyvinyl butyral, polyvinyl chloride, polyvinyl carbazole, polyvinyl ethers and polyvinyl ketones; vinyl chloride-vinyl acetate copolymers; silicone resins including organosiloxane bonds, and modified products thereof (e.g. modified products made of alkyd resins, polyester resins, epoxy resins, polyurethanes, etc.); fluorine resins such as perfluoroalkyl ethers, polyfluorovinyl, polyfluorovinylidene and polychlorotrifluoroethylene; polyamides; polyesters; polyurethanes; polycarbonates; amino resins such as urea-formaldehyde resins; epoxy resins; and combinations of these resins.

### (Process Cartridge)

A process cartridge of the present invention includes at least an image bearing member and a protective layer forming device for forming a protective layer on a surface of the image bearing member, and further includes other units, as necessary, and the process cartridge is detachably attached to an image forming apparatus body. The protective layer forming unit is the protective layer forming device of the present invention.

FIG. 3 is a cross sectional view showing a schematic configuration example of a process cartridge using the protective layer forming device of the present invention.

A shown in FIGS. 1A and 2 in detail, a protective layer forming device 2 is placed facing a photoconductor drum 1 as the image bearing member, and mainly includes a powdery image-bearing member protecting agent 21, a protecting agent supply member 22, a protecting agent stirring member 23, and a leveling section (only a leveling member 24 is shown in FIG. 3).

On the surface of the image bearing member 1 after image formation, the image-bearing member protecting agent which has been partly deteriorated after the transfer step, toner components and the like remain. The residue on the surface is cleaned using a cleaning member 41.

In FIG. 3, the cleaning member 41 is in contact with the image bearing member 1 at an angle related to a so-called counter type (leading type).

To the surface of the image bearing member, from which the residual toner and deteriorated image-bearing member protecting agent are removed by a cleaning mechanism 4, the image-bearing member protecting agent 21 is supplied via the protecting agent supply member 22, thereby forming a protective layer using the leveling member 24 of the leveling section. The surface of the image bearing member, on which the protective layer has been formed, is charged, and then exposed by a laser so as to form a latent electrostatic image thereon, and then the latent electrostatic image is developed and formed into a visible image using a developing unit 5, and then transferred onto a recording medium 7 by a transfer roller 6 which is located outside of the process cartridge. In FIG. 3, 51 denotes a developing sleeve, and 52 and 53 respectively denote stirring members.

### (Image Forming Apparatus)

The image forming apparatus of the present invention includes at least an image bearing member, a latent electrostatic image forming unit configured to form a latent electrostatic image on the image bearing member, a developing unit configured to develop the latent electrostatic image using a toner so as to form a visible image, a transfer unit configured to transfer the visible image onto a recording medium, a protective layer forming unit configured to form a protective layer on the surface of the image bearing member, and further includes other units as necessary.

The protective layer forming unit is the protective layer forming device of the present invention.

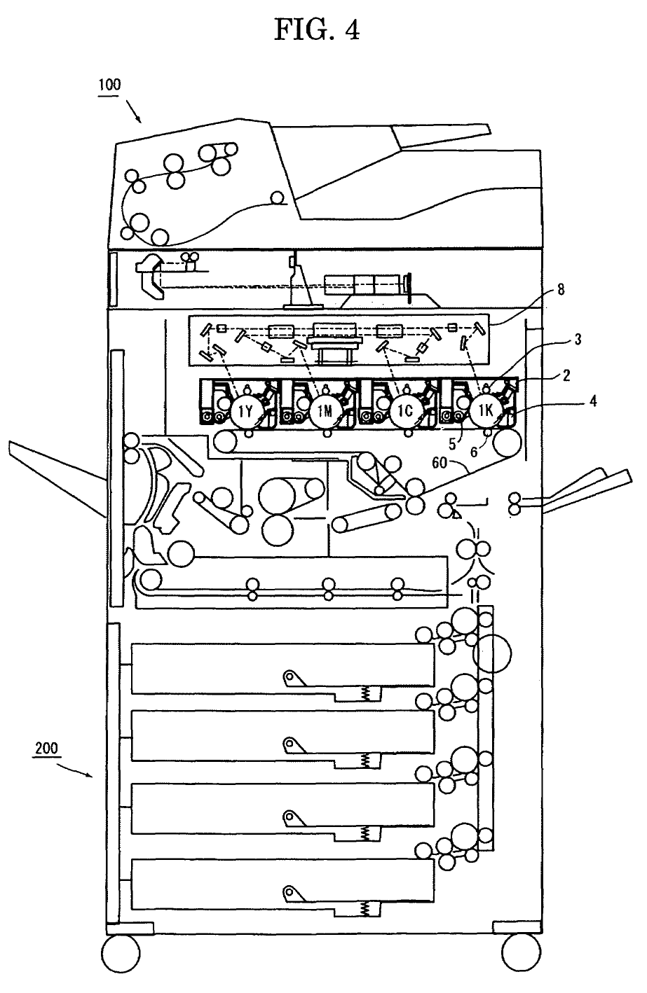

FIG. 4 is a cross sectional view showing an example of an image forming apparatus 100 equipped with the protective layer forming device of the present invention.

The configurations of each of process cartridges are the same, except that the colors of toners used are different. Therefore, the symbols Y, M, C, and K are omitted, except for the image bearing members.

In FIG. 4, protective layer forming devices 2, charging units 3, a latent image forming unit 8, developing units 5, image transferring units 6 and cleaning units 4 are arranged around drum-shaped image bearing members 1Y, 1M, 1C and 1K for respective colors, and image formation is conducted through the following processes.

A process for image formation will be explained with an example of a negative-positive process. The image bearing members 1Y, 1M, 1C, 1K, each of which is typified by a photoconductor having an organic photoconductive layer (OPC), are subjected to charge elimination by a charge-eliminating lamp (not shown) or the like, then the image bearing members 1Y, 1M, 1C, 1K are negatively charged in a uniform manner by the charging units 3 having charging members.

When each of the image bearing members 1Y, 1M, 1C, 1K is charged by each of the charging units 3, a voltage of appropriate intensity or a charging voltage obtained by superimposing an AC voltage onto the voltage, which is suitable for charging the image bearing members 1Y, 1M, 1C, 1K to a desired electric potential, is applied from a voltage applying mechanism (not shown) to each of the charging units 3.

On the charged image bearing members 1Y, 1M, 1C, 1K, an latent electrostatic image is formed by irradiating with the laser beam from the latent electrostatic image forming unit 8 (the absolute value of the electric potential of the exposed portion is smaller than that of the electric potential of the unexposed portion).

The laser beam is emitted from a semiconductor laser, and the surface of the image bearing members 1Y, 1M, 1C, 1K are scanned in the direction of the rotational shafts of the image bearing members 1Y, 1M, 1C, 1K, using a multifaceted mirror of a polygonal column (polygon mirror) or the like which rotates at high speed.

The thus formed latent electrostatic image is developed with a developer which contains toner particles or a mixture of toner particles and carrier particles, which is supplied onto each of developing sleeves serving as developer bearing members in each of the developing units 5, so as to form a visible toner image.

When the latent image is developed, a voltage of appropriate intensity or a developing bias obtained by superimposing an AC voltage onto the voltage is applied from a voltage applying mechanism (not shown) to a developing sleeve, with the intensity being between the intensities of the voltages for the exposed portion and the unexposed portion of the image bearing members 1Y, 1M, 1C, 1K.

Toner images formed on the image bearing members 1Y, 1M, 1C, 1K for respective colors are respectively transferred onto an intermediate transfer medium 60 by the transfer units 6, and then transferred onto a recording medium such as paper, fed from a sheet feeding mechanism 200.

An electric potential having the opposite polarity to the polarity of charging the toner is preferably applied to each of the transfer units 6 as a transfer bias. Then the intermediate transfer member 60 is separated from the image bearing members 1Y, 1M, 1C, 1K, thereby obtaining a transferred image on the recording medium.

After transferring, toner particles remaining on each image bearing member 1Y, 1M, 1C, 1K are recovered into a toner recovery chamber inside the cleaning units 4 by the cleaning members 41 (FIG. 2).

The image forming apparatus 100 may be an apparatus in which a plurality of developing units 5 described above are arranged to sequentially transfer toner images of different colors sequentially formed by the developing units 5 onto a recording medium, and the recording medium is sent to a fixing mechanism to fix toner images by heat, or the like, or may be an apparatus in which a plurality of toner images are transferred onto an intermediate transfer medium once, and the toner images on the intermediate transfer medium are transferred onto a recording medium such as paper at a time to be fixed in a similar manner as mentioned above.

The charging units 3 are not particularly limited, and any known configuration may be used. The charging units located in contact with or close to the surfaces of the image bearing members are more preferred. This allows to greatly reduce the amount of ozone generated upon charging in comparison with that generated by a corona discharger using a discharge wire such as a corotron and a scorotron.

However, in the charging unit configured to locate the charging member in contact with or close to the surface of the image bearing member so as to charge the surface of the image bearing member, electric discharge as described above is performed in the vicinity of the image bearing member, thus an electrical stress on the image bearing member tends to be larger. By the use of the protective layer forming device of the present invention, the image bearing member can be maintained without deterioration for a long period of time. Therefore, image change with time and image change under operational environments can be suppressed, and stable image quality can be secured.

### EXAMPLE

Hereinafter, the present invention will be explained with reference to the following Examples; however, these Examples are intended to illustrate the invention and are not to be construed to limit the scope of the present invention.

### Production Example 1

### Production of Image-Bearing Member Protecting Agent 1

Zinc stearate as a fatty acid metal salt (A) and boron nitride as an inorganic lubricant (B) were mixed according to the mixing ratio (on a mass basis) shown in Tables 1-1 and 1-2.

The mixing was performed at 25,000 rpm for 10 seconds using WONDER BLENDER WB-1 (available from OSAKA CHEMICAL Co., Ltd.) twice, thereby obtaining a sample of a mixed powder.

The amount of each raw material to be loaded to a mold was calculated from a specific gravity, a mixing ratio and a desired filling rate thereof which have been measured beforehand.

The measured composition of Image-Bearing Member Protecting Agent 1 was poured into an aluminum mold having a dimension of 20 mm depth×8 mm width×350 mm length, and the surface thereof was leveled off by a spatula, and compressed by pressure using a die, so as to obtain a filled product having a height of 8 mm. Thus, a powder compacted product was formed.

The solid formed of a composition of Image-Bearing Member Protecting Agent 1 was taken out from the mold, and shaped into a mass having a dimension of 8 mm×8 mm×310 mm, and attached to a metal support, thereby producing Image-Bearing Member Protecting Agent 1.

### Production Examples 2 to 4

### Production of Image-Bearing Member Protecting Agents 2 to 4

Image-Bearing Member Protecting Agents 2 to 4 were produced in the same manner as Image-Bearing Member Protecting Agent 1, except that raw materials of Image-Bearing Member Protecting Agents 2 to 4 were as shown in Tables 1-1 and 1-2.

### Comparative Production Example 1

### Production of Image-Bearing Member Protecting Agent 5

Image-Bearing Member Protecting Agent 5 was produced in the same manner as Image-Bearing Member Protecting Agent 1, except that only one fatty acid metal salt (A) shown in Table 1-1 was used as Image-Bearing Member Protecting Agent 5.

### Comparative Production Example 2

### Production of Image-Bearing Member Protecting Agent 6

Image-Bearing Member Protecting Agent 6 was produced in the same manner as Image-Bearing Member Protecting Agent 1, except that two types of fatty acid metal salts (A) shown in Table 1-1 were mixed as Image-Bearing Member Protecting Agent 6.

### Comparative Production Example 3

### Production of Image-Bearing Member Protecting Agent 7

Image-Bearing Member Protecting Agent 7 was produced in the same manner as Image-Bearing Member Protecting Agent 1, except that only one inorganic lubricant (B) shown in Table 1-2 was used as Image-Bearing Member Protecting Agent 7.

### Comparative Production Example 4

### Production of Image-Bearing Member Protecting Agent 8

Image-Bearing Member Protecting Agent 8 was produced in the same manner as Image-Bearing Member Protecting Agent 1, except that a mixture of a fatty acid metal salt (A) shown in Table 1-1 and Fischer-Topsch wax as an organic lubricant shown in Table 1-2 was used as Image-Bearing Member Protecting Agent 8.

TABLE 1-1

| | Image- | Fatty acid metal salt (A) | | | |
|---|---|---|---|---|---|
| | Bearing | | Amount to | | Amount to |
| | Member | | be mixed | | be mixed |
| | Protecting | | (parts by | | (parts by |
| | Agent | Type | mass) | Type | mass) |
| Production | Protecting | zinc | 80 | — | — |
| Example 1 | Agent 1 | stearate | | | |
| Production | Protecting | calcium | 80 | — | — |
| Example 2 | Agent 2 | stearate | | | |
| Production | Protecting | zinc | 80 | — | — |
| Example 3 | Agent 3 | stearate | | | |
| Production | Protecting | calcium | 80 | — | — |
| Example 4 | Agent 4 | stearate | | | |
| Comparative | Protecting | zinc | 100 | — | — |
| Production | Agent 5 | stearate | | | |
| Example 1 | | | | | |
| Comparative | Protecting | zinc | 80 | calcium | 20 |
| Production | Agent 6 | stearate | | stearate | |
| Example 2 | | | | | |
| Comparative | Protecting | — | — | — | — |
| Production | Agent 7 | | | | |
| Example 3 | | | | | |
| Comparative | Protecting | zinc | 80 | — | — |
| Production | Agent 8 | stearate | | | |
| Example 4 | | | | | |

TABLE 1-2

| | | Inorganic | | | |
|---|---|---|---|---|---|
| | Image- | lubricant (B) | | Organic lubricant | |
| | Bearing | | Amount to | | amount to |
| | Member | | be mixed | | be mixed |
| | Protecting | | (parts by | | (parts by |
| | Agent | Type | mass) | Type | mass) |
| Production | Protecting | boron | 20 | — | — |
| Example 1 | Agent 1 | nitride | | | |
| Production | Protecting | boron | 20 | — | — |
| Example 2 | Agent 2 | nitride | | | |
| Production | Protecting | mica | 20 | — | — |
| Example 3 | Agent 3 | | | | |
| Production | Protecting | mica | 20 | — | — |
| Example 4 | Agent 4 | | | | |
| Comparative | Protecting | — | — | — | — |
| Production | Agent 5 | | | | |
| Example 1 | | | | | |
| Comparative | Protecting | — | — | — | — |
| Production | Agent 6 | | | | |
| Example 2 | | | | | |
| Comparative | Protecting | boron | 100 | — | — |
| Production | Agent 7 | nitride | | | |
| Example 3 | | | | | |
| Comparative | Protecting | — | — | Fischer- | 20 |
| Production | Agent 8 | | | Tropsch | |
| Example 4 | | | | wax | |

### Example 1

Following to a transferring unit, as shown in FIG. 1A, around an image bearing member (photoconductor) 1 having an outer diameter of 40 mm, a brush-shaped protecting agent supply member 22 and Leveling Member 1 as a leveling member 24 which served as a counter-type blade were arranged in this order from the upstream of the rotation direction of the image bearing member 1, thereby producing a process cartridge having a protective layer forming device using Image-Bearing Member Protecting Agent 1 as an image-bearing member protecting agent 21. A hard resin roller having a diameter of 12 mm was used as a charging member 3, and a gap between the charging member 3 and the photoconductor was adjusted to 50 μm.

Leveling Member 1 as the leveling member 24 was in contact with the image bearing member 1 under the conditions of an obtuse angle of 120 degrees, a contact linear pressure of 0.3N/cm, a Young's modulus of 0.07 N/cm², and a contact width of 50 μm.

Leveling Member 1 was produced by punching an urethane rubber sheet having a thickness of 2 mm into a shape of 350 mm width (the width is decided according to an image width)×12 mm length. Next, Leveling Member 1 was set in a jig for forming an obtuse angle, and the edge was cut into an obtuse angle shape. Then, a portion of Leveling Member 1 in a length of 5 mm was adhered to a support made of a sheet metal. Thus, a protrusion amount was 7 mm.

The process cartridge thus configured was attached to a Color MFP (IMAGIO NEO C3500, manufactured by Ricoh Company, Ltd.), which was modified so that the process cartridge could be attached, and a continuous image formation test was performed, in which images were continuously formed on 100,000 sheets of A4 size paper with an image area ratio of 5%. The charging condition is such that an application of alternating electric field, in which a sine wave with Vpp of 3 kV and frequency of 1.5 kHz as an AC component is superimposed on −600V DC component.

Next, occurrences of abnormal images before and after continuous image formation test were examined in a normal-temperature and normal-humidity environment at 20° C. and 50% RH, in a low-temperature and low-humidity environment at 10° C. and 25% RH, and in a high-temperature and high-humidity environment at 35° C. and 80% RH.

The abnormal images occurring after continuous image formation test were evaluated on the basis of the following criteria for evaluating streaky image defect, uneven halftone image, background fogging and image blur, which related to cleanability.

The evaluation results are shown in Tables 3-1, 3-2, 4-1, 4-2 and 5, and the criteria for the evaluation on the streaky image defect, uneven halftone image, background fogging and image blur are as follows:

### <Criteria for the Evaluation on Streaky Image Defect>

A: Excellent
B: No problem from a practical standpoint
C: Allowable to use from a practical standpoint
D: Unallowable to use

### <Criteria for Evaluation on Uneven Halftone Image>

A: Excellent
B: No problem from a practical standpoint
C: Allowable to use from a practical standpoint
D: Unallowable to use

### <Criteria for the Evaluation on Image Blur>

A: Excellent
B: No problem from a practical standpoint
C: Allowable to use from a practical standpoint
D: Unallowable to use

### <Evaluation Method of Background Fogging>

Samples for grading No. 1 to No. 5 of background fogging were produced in advance, and IDs of the samples were measured by X-Rite 938, so as to obtain a calibration curve. Then, the ID of a sample to be evaluated was measured and evaluated on the basis of the following criteria. The more severely the background fogging occurred, the higher the ID became. The background fogging became severe in the order of the samples for grading from No. 5 to No. 1.

### <Criteria for the Evaluation on Background Fogging>

A: Remarkably excellent (the samples for grading No. 4 to No. 5)
B: Excellent (the samples for grading No. 3 or more to less than No. 4)
C: Slightly inferior (the samples for grading No. 2 or more to less than No. 3)
D: Inferior (the samples for grading No. 1 or more to less than No. 2)

Upon output of 100,000 sheets, the surface of the image-bearing member protecting agent was visually observed whether or not contaminant adhered thereto, and was evaluated on the basis of the following evaluation criteria.

### <Criteria for the Evaluation on the State of Image-Bearing Member Protecting Agent>

A: No contamination was observed.
B: Slight contamination was observed.
C: Contamination was scattered over the image-bearing member protecting agent (Allowable to use from a practical standpoint)
D: Contamination was spread over a wide area of the image-bearing member protecting agent.

Furthermore, in order to evaluate the effect on images caused by the deterioration occurred in the image bearing member, the cleaning blade serving as the leveling member and the charge member, the state and the presence of abnormality of each member were observed at the beginning and upon output of 100,000 sheets, and then observation results were evaluated with the following criteria.

### <Criteria for the Evaluation on the State of Each Member>

A: The state was the same as the beginning
B: Some deterioration was recognized (allowable to use from a practical standpoint)
C: Deterioration was recognized

As a result of the above test, the evaluation results of image qualities at the beginning are shown in Tables 3-1 and 3-2, and those after continuous image formation are shown in Tables 4-1 and 4-2, and the observation results of the deterioration states of members are shown in Table 5.

Table 2 shows various conditions of the obtuse angle, the linear pressure, the Young's modulus of the cleaning blade serving as the leveling member and the contact width between the blade and the image bearing member.

The obtuse angle of the cleaning blade was measured by enlarging the cross section of the blade.

The Young's modulus of the cleaning blade was obtained by means of a tension test in accordance with JIS K6254.

The linear pressure of the cleaning blade was obtained by calculating from the Young's modulus of the cleaning blade, the protrusion amount, and the bite amount.

The contact width between the cleaning blade and the image bearing member was obtained in such a manner that the image bearing member was coated with something for marking, and the image bearing member was in contact with the cleaning blade and rotated a several times, and then a width of the marker attached onto the blade was measured.

Meanwhile, the obtuse angle was changed by adjusting the setting of the jig. The Young's modulus was changed by changing the blade material. The linear pressure and the contact width were changed by changing the Young's modulus of the blade, the obtuse angle, the protrusion amount, and the bite amount.

TABLE 2

| | | Obtuse | Linear | Young's | Contact |
|---|---|---|---|---|---|
| | Leveling | angle | pressure | modulus | width |
| | Member | (degree) | (N/cm) | (N/cm²) | (μm) |
| Example 1 | Leveling | 120 | 0.3 | 0.07 | 50 |
| | Member 1 | | | | |
| Example 5 | Leveling | 95 | 0.1 | 0.03 | 10 |
| | Member 2 | | | | |
| Example 6 | Leveling | 170 | 2 | 0.2 | 100 |
| | member 3 | | | | |
| Example 7 | Leveling | 95 | 0.1 | 0.2 | 10 |
| | Member 4 | | | | |
| Example 8 | Leveling | 170 | 2 | 0.03 | 100 |
| | Member 5 | | | | |
| Example 9 | Leveling | 100 | 0.1 | 0.06 | 10 |
| | Member 6 | | | | |
| Example 10 | Leveling | 150 | 2 | 0.15 | 70 |
| | member 7 | | | | |
| Example 11 | Leveling | 100 | 0.1 | 0.15 | 10 |
| | Member 8 | | | | |
| Example 12 | Leveling | 150 | 2 | 0.06 | 70 |
| | member 9 | | | | |
| Example 14 | Leveling | 93 | 0.3 | 0.07 | 50 |
| | Member 10 | | | | |
| Example 15 | Leveling | 172 | 0.3 | 0.07 | 50 |
| | Member 11 | | | | |
| Example 16 | Leveling | 120 | 0.08 | 0.07 | 50 |
| | Member 12 | | | | |
| Example 17 | Leveling | 120 | 2.1 | 0.07 | 50 |
| | member 13 | | | | |
| Example 18 | Leveling | 120 | 0.3 | 0.01 | 50 |
| | Member 14 | | | | |
| Example 19 | Leveling | 120 | 0.3 | 0.21 | 50 |
| | Member 15 | | | | |
| Example 20 | Leveling | 120 | 0.3 | 0.07 | 8 |
| | Member 16 | | | | |
| Example 21 | Leveling | 120 | 0.3 | 0.07 | 110 |
| | Member 17 | | | | |
| Comparative | Leveling | 45 | 0.3 | 0.07 | 20 |
| Example 5 | Member 18 | (acute angle) | | | |

### Examples 2 to 4

Examples 2 to 4 were evaluated in the same manner as in Example 1, except that Image-Bearing Member Protecting Agent 1 was changed to Image-Bearing Member Protecting Agents 2 to 4.

The evaluation results of image quality and the presence or absence of the contaminant adhered on the image-bearing member protecting agent at the beginning are shown in Tables 3-1 and 3-2, and those after continuous image formation are shown in Tables 4-1 and 4-2, and the observation results of the deterioration state of each member are shown in Table 5.

### Comparative Examples 1 to 4

Comparative Examples 1 to 4 were evaluated in the same manner as in Example 1, except that Image-Bearing Member Protecting Agent 1 was changed to Image-Bearing Member Protecting Agents 5 to 8.

The evaluation results of image quality and the presence or absence of the contaminant adhered on the image-bearing member protecting agent at the beginning are shown in Tables 3-1 and 3-2, and those after continuous image formation are shown in Tables 4-1 and 4-2, and the observation results of the deterioration state of each member are shown in Table 5.

### Examples 5 to 12

Examples 5 to 12 were evaluated in the same manner as in Example 1, except that Leveling Member 1 in Example 1 was respectively replaced with Leveling Members 2 to 9 as shown in Table 2.

The evaluation results of image quality and the presence or absence of the contaminant adhered on the image-bearing member protecting agent at the beginning are shown in Tables 3-1 and 3-2, and those after continuous image formation are shown in Tables 4-1 and 4-2, and the observation results of the deterioration state of each member are shown in Table 5.

### Examples 14 to 21

Examples 14 to 21 were evaluated in the same manner as in Example 1, except that Leveling Member 1 in Example 1 was respectively replaced with Leveling Members 10 to 17 as shown in Table 2.

The evaluation results of image quality and the presence or absence of the contaminant adhered on the image-bearing member protecting agent at the beginning are shown in Tables 3-1 and 3-2, and those after continuous image formation are shown in Tables 4-1 and 4-2, and the observation results of the deterioration state of each member are shown in Table 5.

### Comparative Examples 5 and 6

Comparative Example 5 was evaluated in the same manner as in Example 1, except that Leveling Member 1 in Example 1 was replaced with Leveling Member 18 as shown in Table 2.

Comparative Example 6 was evaluated in the same manner as in Example 1, except that Leveling Member 1 was used in a trailing system.

The evaluation results of image quality and the presence or absence of the contaminant adhered on the image-bearing member protecting agent at the beginning are shown in Tables 3-1 and 3-2, and those after continuous image formation are shown in Tables 4-1 and 4-2, and the observation results of the deterioration state of each member are shown in Table 5.

### Example 13

Following to a transferring unit, as show in FIG. 2, around an image bearing member 1 (photoconductor) having an outer diameter of 40 mm, a counter type cleaning blade 41, a brush-shaped protecting agent supply member 22 and Leveling Member 1 serving as a leveling member 24 which was a counter blade type were arranged in this order from the upstream of the rotation direction of the image bearing member, thereby producing a process cartridge having a protective layer forming device using Image-Bearing Member Protecting Agent 1 as an image-bearing member protecting agent 21. A hard resin roller having a diameter of 12 mm was used as a charging member 3, and a gap between the charging member 3 and the photoconductor was adjusted to 50 μm.

Leveling Member 1 as the leveling member 24 was in contact with the image bearing member 1 under the conditions of an obtuse angle of 120 degrees, a contact linear pressure of 0.3 N/cm, a Young's modulus of 0.07 N/cm², and a contact width of 50 μm.

The process cartridge thus configured was attached to Color MFP IMAGIO NEO C3500, manufactured by Ricoh Company, Ltd.), which was modified so that the process cartridge could be attached, and a continuous image formation test was performed, in which images were continuously formed on 100,000 sheets of A4 size paper with an image area ratio of 5%, and then the evaluation was performed in the same manner as in Example 1.

The evaluation results of image qualities at the beginning are shown in Tables 3-1 and 3-2 and those after continuous image formation are shown in Tables 4-1 and 4-2, and the observation results of the deterioration states of members are shown in Table 5.

TABLE 3-1

| | Image quality (normal | | | | | Image quality (low | | | | |
|---|---|---|---|---|---|---|---|---|---|---|
| | temperature/normal humidity) | | | | | temperature/low humidity) | | | | |
| | | | Back- | | | | | Back- | | |
| | Streaky | Uneven | ground | Image | Contaminant | Streaky | Uneven | ground | Image | Contaminant |
| | image | image | fogging | blur | adhesion | image | image | fogging | blur | adhesion |
| Ex. 1 | A | A | A | A | A | A | A | A | A | A |
| Ex. 2 | A | B | A | A | A | A | B | A | A | A |
| Ex. 3 | A | B | A | A | A | A | B | A | A | A |
| Ex. 4 | B | B | A | A | A | B | B | A | A | A |
| Ex. 5 | B | A | A | A | A | B | A | A | A | A |
| Ex. 6 | A | A | A | A | A | A | A | A | A | A |
| Ex. 7 | A | A | A | A | A | A | A | A | A | A |
| Ex. 8 | A | A | A | A | A | A | A | A | A | A |
| Ex. 9 | A | A | A | A | A | A | A | A | A | A |
| Ex. 10 | A | A | A | A | A | A | A | A | A | A |
| Ex. 11 | A | A | A | A | A | A | A | A | A | A |
| Ex. 12 | A | A | A | A | A | A | A | A | A | A |
| Ex. 13 | A | A | A | A | A | A | A | A | A | A |

| | Image quality (high | | | | |
|---|---|---|---|---|---|
| | temperature/high humidity) | | | | |
| | | | Back- | | |
| | Streaky | Uneven | ground | | Contaminant |
| | image | image | fogging | Image blur | adhesion |
| Ex. 1 | A | A | A | A | A |
| Ex. 2 | A | B | A | A | A |
| Ex. 3 | A | B | A | A | A |
| Ex. 4 | B | B | A | A | A |
| Ex. 5 | B | A | A | A | A |
| Ex. 6 | A | A | A | A | A |
| Ex. 7 | A | A | A | A | A |
| Ex. 8 | A | A | A | A | A |
| Ex. 9 | A | A | A | A | A |
| Ex. 10 | A | A | A | A | A |
| Ex. 11 | A | A | A | A | A |
| Ex. 12 | A | A | A | A | A |
| Ex. 13 | A | A | A | A | A |

TABLE 3-2

| | Image quality (normal | | | | | Image quality (low | | | | |
|---|---|---|---|---|---|---|---|---|---|---|
| | temperature/normal humidity) | | | | | temperature/low humidity) | | | | |
| | | | Back- | | | | | Back- | | |
| | Streaky | Uneven | ground | Image | Contaminant | Streaky | Uneven | ground | Image | Contaminant |
| | image | image | fogging | blur | adhesion | image | image | fogging | blur | adhesion |
| Ex. 14 | B | A | A | A | A | B | A | A | A | A |
| Ex. 15 | B | A | A | A | A | B | A | A | A | A |
| Ex. 16 | C | A | A | A | A | C | A | A | A | A |
| Ex. 17 | A | A | A | A | A | A | A | A | A | A |
| Ex. 18 | A | A | A | A | A | B | A | A | A | A |
| Ex. 19 | A | A | A | A | A | A | A | A | A | A |
| Ex. 20 | C | A | A | A | A | C | A | A | A | A |
| Ex. 21 | B | A | A | A | A | C | A | A | A | A |
| Comp. Ex. 1 | A | A | A | A | A | A | A | A | A | A |
| Comp. Ex. 2 | A | A | A | A | A | B | A | A | A | A |
| Comp. Ex. 3 | D | D | D | D | A | D | D | D | D | A |
| Comp. Ex. 4 | D | D | A | A | A | D | D | A | A | A |
| Comp. Ex. 5 | C | A | A | A | A | C | A | A | A | A |
| Comp. Ex. 6 | C | A | A | A | A | C | A | A | A | A |

| | Image quality (high | | | | |
|---|---|---|---|---|---|
| | temperature/high humidity) | | | | |
| | | | Back- | | |
| | Streaky | Uneven | ground | | Contaminant |
| | image | image | fogging | Image blur | adhesion |
| Ex. 14 | B | A | A | A | A |
| Ex. 15 | B | A | A | A | A |
| Ex. 16 | C | A | A | A | A |
| Ex. 17 | A | A | A | A | A |
| Ex. 18 | A | A | A | A | A |
| Ex. 19 | A | A | A | A | A |
| Ex. 20 | C | A | A | A | A |
| Ex. 21 | B | A | A | A | A |
| Comp. Ex. 1 | A | A | A | A | A |
| Comp. Ex. 2 | A | A | A | A | A |
| Comp. Ex. 3 | D | D | D | D | A |
| Comp. Ex. 4 | D | D | A | C | A |
| Comp. Ex. 5 | C | A | A | A | A |
| Comp. Ex. 6 | C | A | A | A | A |

TABLE 4-1

| | Image quality (normal | | | | | Image quality (low | | | | |
|---|---|---|---|---|---|---|---|---|---|---|
| | temperature/normal humidity) | | | | | temperature/low humidity) | | | | |
| | | | Back- | | | | | Back- | | |
| | Streaky | Uneven | ground | Image | Contaminant | Streaky | Uneven | ground | Image | Contaminant |
| | image | image | fogging | blur | adhesion | image | image | fogging | blur | adhesion |
| Ex. 1 | A | A | A | A | A | A | A | A | A | A |
| Ex. 2 | A | B | A | A | A | A | B | A | A | A |
| Ex. 3 | B | B | A | A | A | B | B | A | A | A |
| Ex. 4 | B | B | A | A | A | C | B | A | A | A |
| Ex. 5 | B | A | A | A | A | C | A | A | A | A |
| Ex. 6 | B | A | A | A | A | C | A | A | A | A |
| Ex. 7 | B | A | A | A | A | B | A | A | A | A |
| Ex. 8 | B | A | A | A | A | C | A | A | A | A |
| Ex. 9 | A | A | A | A | A | B | A | A | A | A |
| Ex. 10 | A | A | A | A | A | B | A | A | A | A |
| Ex. 11 | A | A | A | A | A | B | A | A | A | A |
| Ex. 12 | A | A | A | A | A | B | A | A | A | A |
| Ex. 13 | A | A | A | A | A | A | A | A | A | A |

| | Image quality (high | | | | |
|---|---|---|---|---|---|
| | temperature/high humidity) | | | | |
| | | | Back- | | |
| | Streaky | Uneven | ground | | Contaminant |
| | image | image | fogging | Image blur | adhesion |
| Ex. 1 | A | A | A | A | A |
| Ex. 2 | A | B | A | A | A |
| Ex. 3 | B | B | A | A | A |
| Ex. 4 | B | B | A | A | A |
| Ex. 5 | B | A | A | A | A |
| Ex. 6 | B | A | A | A | A |
| Ex. 7 | B | A | A | A | A |
| Ex. 8 | B | A | A | A | A |
| Ex. 9 | A | A | A | A | A |
| Ex. 10 | A | A | A | A | A |
| Ex. 11 | A | A | A | A | A |
| Ex. 12 | A | A | A | A | A |
| Ex. 13 | A | A | A | A | A |

TABLE 4-2

| | Image quality (normal | | | | | Image quality (low | | | | |
|---|---|---|---|---|---|---|---|---|---|---|
| | temperature/normal humidity) | | | | | temperature/low humidity) | | | | |
| | | | Back- | | | | | Back- | | |
| | Streaky | Uneven | ground | Image | Contaminant | Streaky | Uneven | ground | Image | Contaminant |
| | image | image | fogging | blur | adhesion | image | image | fogging | blur | adhesion |
| Ex. 14 | C | A | A | A | A | C | A | A | A | A |
| Ex. 15 | C | A | A | A | A | C | A | A | A | A |
| Ex. 16 | C | A | A | A | A | C | A | A | A | A |
| Ex. 17 | C | A | A | A | A | C | A | A | A | A |
| Ex. 18 | C | A | A | A | A | C | A | A | A | A |
| Ex. 19 | C | A | A | A | A | C | A | A | A | A |
| Ex. 20 | C | A | A | A | A | C | A | A | A | A |
| Ex. 21 | C | A | A | A | A | C | A | A | A | A |
| Comp. Ex. 1 | C | A | A | A | A | D | A | A | A | A |
| Comp. Ex. 2 | C | B | A | A | A | D | B | A | A | A |
| Comp. Ex. 3 | D | D | D | D | D | D | D | D | D | D |
| Comp. Ex. 4 | D | D | A | A | D | D | D | A | A | D |
| Comp. Ex. 5 | D | A | A | D | D | D | A | A | D | D |
| Comp. Ex. 6 | D | A | A | D | D | D | A | A | D | D |

| | Image quality (high | | | | |
|---|---|---|---|---|---|
| | temperature/high humidity) | | | | |
| | | | Back- | | |
| | Streaky | Uneven | ground | | Contaminant |
| | image | image | fogging | Image blur | adhesion |
| Ex. 14 | C | A | A | A | A |
| Ex. 15 | C | A | A | A | A |
| Ex. 16 | C | A | A | A | A |
| Ex. 17 | C | A | A | A | A |
| Ex. 18 | C | A | A | A | A |
| Ex. 19 | C | A | A | A | A |
| Ex. 20 | C | A | A | A | A |
| Ex. 21 | C | A | A | A | A |
| Comp. Ex. 1 | C | A | A | A | A |
| Comp. Ex. 2 | C | B | A | A | A |
| Comp. Ex. 3 | D | D | D | D | D |
| Comp. Ex. 4 | D | D | A | D | D |
| Comp. Ex. 5 | D | A | A | D | D |
| Comp. Ex. 6 | D | A | A | D | D |

TABLE 5

| | Image bearing | Leveling | Cleaning | Charging |
|---|---|---|---|---|
| | member | member | member | member |
| Example 1 | A | A | — | A |
| Example 2 | B | A | — | A |
| Example 3 | B | A | — | B |
| Example 4 | B | A | — | B |
| Example 5 | A | A | — | B |
| Example 6 | B | B | — | B |
| Example 7 | A | A | — | B |
| Example 8 | B | B | — | B |
| Example 9 | A | A | — | A |
| Example 10 | A | A | — | A |
| Example 11 | A | A | — | A |
| Example 12 | A | A | — | A |
| Example 13 | A | A | A | A |
| Example 14 | A | B | — | B |
| Example 15 | A | B | — | B |
| Example 16 | A | A | — | B |
| Example 17 | B | B | — | B |
| Example 18 | A | A | — | B |
| Example 19 | A | A | — | B |
| Example 20 | A | B | — | B |
| Example 21 | A | B | — | B |
| Comparative | A | C | — | C |
| Example 1 | | | | |
| Comparative | A | C | — | C |
| Example 2 | | | | |
| Comparative | C | C | — | C |
| Example 3 | | | | |
| Comparative | B | C | — | C |
| Example 4 | | | | |
| Comparative | A | C | — | C |
| Example 5 | | | | |
| Comparative | A | B | — | C |
| Example 6 | | | | |

As can be seen from the results of Tables 3-1 to 5, Examples 1 to 13 were superior to Comparative Examples 1 to 6 in image quality, i.e. less occurrence of streaky image, uneven image, image blur and the like. Moreover, the image bearing member, the cleaning member and the charging member were less deteriorated due to an increase in the number of sheets output.

In Example 1, the deterioration of each member due to an increase in the number of sheets output was not observed, excellent image quality was obtained at the beginning of and after the output of 100,000 sheets, and an abnormal image was not observed after heat recycle, therefore it was found that the image forming apparatus of the present invention was useful in terms of image quality and lifetime.

By the use of the image forming apparatus in Example 1, after the continuous image formation test, further images were formed on 500,000 sheets in total, having no influence on the images. Moreover, the deterioration of the image bearing member, the leveling member, and the charging member were hardly observed.

In Example 2, the film formation of the fatty acid metal salt of the Image-Bearing Member Protecting Agent 2 was rather slow, and the image bearing member 1 was slightly deteriorated. However, the properties of the image-bearing member protecting agent of Example 2 were equivalent to those of Example 1.

In Example 3, the inorganic lubricant of the Image-Bearing Member Protecting Agent 3 had rather poor lubricating property, and the charging member and the leveling member were slightly deteriorated. However, the other properties of the image-bearing member protecting agent of Example 3 were equivalent to those of Example 1.

In Example 4, the Image-Bearing Member Protecting Agent 4 had rather poor film forming property and lubricating property, and the image bearing member, the charging member and the leveling member were slightly deteriorated.

In Examples 5 to 12, the protective layer forming device used Leveling Members 2 to 9, respectively. In the case where the leveling member had a low linear pressure in Examples 5, 7, 9 and 11, the leveling member exhibited rather poor cleanability, and the charging member was slightly deteriorated; on the other hand, in the case where the leveling member had a high linear pressure in Examples 6, 8, 10 and 12, the protective layer forming device or the image bearing member was slightly deteriorated.

In Comparative Examples 1 to 4, the charging member and the leveling member were deteriorated due to poor lubricating property caused by deterioration of the image-bearing member protecting agent, or all members were deteriorated because the image-bearing member protecting agent itself had poor film forming property.

In Example 14, Leveling Member 10 having an obtuse angle of less than the lower limit of the obtuse angle of the present invention was used as the leveling member, and the tip of the leveling member was buckled.

In Example 15, Leveling Member 11 having an obtuse angle of more than the upper limit of the obtuse angle of the present invention was used as the leveling member, and a large area of a cut surface was in contact with the image bearing member.

In Example 16, Leveling Member 12 having a contact linear pressure with respect to the image bearing member of less than the lower limit of the contact linear pressure of the present invention was used as the leveling member, and the pressing force was not sufficient.

In Example 17, Leveling Member 13 having a contact linear pressure with respect to the image bearing member of more than the upper limit of the contact linear pressure of the present invention was used as the leveling member, and the leveling member or the image bearing member was deteriorated by excessive pressing force.

In Example 18, Leveling Member 14 having a Young's modulus of less than the lower limit of Young's modulus of the present invention was used as the leveling member, and the leveling member could not sufficiently remove the toner and the image-bearing member protecting agent.

In Example 19, Leveling Member 15 having a Young's modulus of more than the upper limit of Young's modulus of the present invention was used as the leveling member, and Young's modulus was so excessive that vibration of the leveling member was increased.

In Example 20, Leveling Member 16 having a contact width with respect to the image bearing member of less than the lower limit of the contact width of the present invention was used as the leveling member, the contact width was insufficient, causing poor cleanability or deterioration of the leveling member, also causing deterioration of the charging member.

In Example 21, Leveling Member 17 having a contact width with respect to the image bearing member of more than the upper limit of the contact width of the present invention was used as the leveling member, the leveling member or the image bearing member was deteriorated due to excessive pressing force.

In Comparative Example 5, the blade had an acute angle and did not have stiffness, the edge of the blade was drawn into rotation, decreasing cleanability. In addition, abrasion increased with time, and degradation with time was rapidly increased.

In Comparative Example 6, Leveling Member 1 in a trailing system had weak blocking force, thus the cleanability was decreased. Therefore, the charging member was severely smeared in the trailing blade, compared to that in the counter blade.

As can be seen from the above-mentioned evaluations, the protective layer forming device of the present invention can protect the image bearing member from electrical stress caused by charging, and mechanical stress caused by rubbing the image bearing member with the cleaning member, and thus are preferably used for an process cartridge, an image forming apparatus, and an image forming method in electrophotography.

What is claimed is:

1. A protective layer forming device comprising:
an image-bearing member protecting agent which comprises a fatty acid metal salt and an inorganic lubricant;
a protecting agent supply member configured to apply a surface of the image bearing member with the image-bearing member protecting agent; and
a leveling member configured to level off the image-bearing member protecting agent applied on the surface of the image bearing member,
wherein the leveling member serves as a cleaning blade having a ridge part with an obtuse angle, which comes into contact with the surface of the image bearing member in a direction counter to the rotation of the image bearing member.

2. The protective layer forming device according to claim 1, wherein the cleaning blade has an obtuse angle of 95 degrees to 170 degrees.

3. The protective layer forming device according to claim 1, wherein the cleaning blade has a contact linear pressure of 0.1 N/cm to 2 N/cm.

4. The protective layer forming device according to claim 1, wherein the cleaning blade has a Young's modulus at 23° C. of 0.03 N/cm² to 0.2 N/cm².

5. The protective layer forming device according to claim 1, wherein the cleaning blade is in contact with the image bearing member with a width of 10 ηm to 100 μm.

6. The protective layer forming device according to claim 1, wherein the image-bearing member protecting agent is supplied via the protecting agent supply member to the surface of the image bearing member.

7. An image forming apparatus comprising:
an image bearing member;
a latent electrostatic image forming unit configured to form a latent electrostatic image on the image bearing member;
a developing unit configured to develop the latent electrostatic image using a toner so as to form a visible image;
a transfer unit configured to transfer the visible image onto a recording medium; and
a protective layer forming unit configured to form a protective layer on a surface of the image bearing member,
wherein the protective layer forming unit includes:
an image-bearing member protecting agent which comprises a fatty acid metal salt and an inorganic lubricant;
a protecting agent supply member configured to apply a surface of the image bearing member with the image-bearing member protecting agent; and
a leveling member configured to level off the image-bearing member protecting agent applied on the surface of the image bearing member,
wherein the leveling member serves as a cleaning blade having a ridge part with an obtuse angle, which comes into contact with the surface of the image bearing member in a direction counter to the rotation of the image bearing member.

8. The image forming apparatus according to claim 7, further comprising a cleaning unit configured to remove a toner remaining on the surface of the image bearing member in a downstream of the transfer unit and an upstream of the protective layer forming unit.

9. The image forming apparatus according to claim 7, wherein the latent electrostatic image forming unit comprises a charging unit located in contact with or close to the surface of the image bearing member.

10. The image forming apparatus according to claim 9, wherein the charging unit comprises a voltage applying unit configured to apply a voltage which includes an AC component.

11. A process cartridge comprising:
an image bearing member; and
a protective layer forming unit configured to form a protective layer on a surface of the image bearing member,
wherein the process cartridge is detachably attached to a main body of the image forming apparatus, and
wherein the protective layer forming unit includes:
an image-bearing member protecting agent which comprises a fatty acid metal salt and an inorganic lubricant;
a protecting agent supply member configured to apply a surface of the image bearing member with the image-bearing member protecting agent; and
a leveling member configured to level off the image-bearing member protecting agent applied on the surface of the image bearing member,
wherein the leveling member serves as a cleaning blade having a ridge part with an obtuse angle, which comes into contact with the surface of the image bearing member in a direction counter to the rotation of the image bearing member.

12. The process cartridge according to claim 11, further comprising a cleaning unit configured to remove a toner remaining on the surface of the image bearing member in an downstream of the transfer unit and an upstream of the protective layer forming unit.

13. The process cartridge according to claim 11, wherein the latent electrostatic image forming unit comprises a charging unit located in contact with or close to the surface of the image bearing member.
